(19) United States
(12) Patent Application Publication
(10) Pub. No.: US 2014/0344198 A1
(43) Pub. Date: Nov. 20, 2014

(54) METHOD AND SYSTEM FOR OPTIMIZATION

(71) Applicants: Evgeny Taits, Bellevue, WA (US); Alexander Khmelnitsky, Bellevue, WA (US)

(72) Inventors: Evgeny Taits, Bellevue, WA (US); Alexander Khmelnitsky, Bellevue, WA (US)

(21) Appl. No.: 14/279,158

(22) Filed: May 15, 2014

Related U.S. Application Data
(60) Provisional application No. 61/824,885, filed on May 17, 2013.
(60) Provisional application No. 61/824,899, filed on May 17, 2013.

(51) Int. Cl. G06N 99/00

(52) U.S. Cl. CPC G06N 99/005
USPC 706/13

(57) ABSTRACT

A system and method provide real-time, optimal and actionable solutions for resource utilization, operations change management, and disruption recovery in complex business environments. An object-defined optimization system and method employs an optimizing engine to provides faster, more cost effective and adaptable ways to multiple, different company, market, and industry applications. Objects are acted upon by the engine and include states and rules to allow the identification of feasible solutions and optimal feasible solutions in near real-time.

### PRIORITY CLAIM

The present application claims priority to U.S. Provisional Application Ser. Nos. 61/824,885 and 61/824,899, both filed May 17, 2013, incorporated by reference as if both fully set forth herein.

### FIELD OF THE INVENTION

This disclosure relates generally to performance improvement, and more particularly, to a method and system for performance optimization.

### BACKGROUND OF THE INVENTION

In practically every conceivable environment, there is a desire to improve the operations of a business. The techniques used to make these improvements tend to not easily adapt to changes in the operation being evaluated and typically are not adaptable across different types of businesses or operations. As a result, the outputs of these techniques are typically less than optimal and take a significant amount of time to process. Accordingly, there is a need for a system and method for operations optimization that performs quickly, is adaptable and produces highly optimal results that are actionable by the operator.

### BRIEF DESCRIPTION OF THE DRAWINGS

Preferred and alternative examples of the present invention are described in detail below with reference to the following drawings:

FIG. 1 is a schematic illustration of an embodiment of the present invention; and,

FIG. 2 is a schematic illustration of an object-defined embodiment of the present invention.

### DETAILED DESCRIPTION OF THE PREFERRED EMBODIMENT

Typically, current optimization software systems are based on linear or mixed-integer programming. Programs such as CPLEX are used in batch fashion and require significant computational power for non-trivial problems. Applications using these programs do not easily adapt to changes that occur in real-time. Other applications employing heuristic approaches can be highly optimized to specific environment and work in real time but the resulting solutions are usually far from optimal.

Two methodologies used in current optimization systems include MIP-based systems utilizing high level language and off-the shelf optimization engines (like CPLEX and Gurobi) and heuristics-based systems (genetic algorithms, evolutionary algorithms, simulated annealing, etcetera.). In the former case, industry specific information is encoded using high level language while optimization engines stay industry agnostic; in the latter case the optimization software system is developed for a specific industry.

A disadvantage of current MIP systems is that, due to the fact they utilize off the shelf optimization engines, they are less efficient in terms of processing time often cannot account for complex real-world constraints that would lead to intractable mathematical problems, and make the overall system less useable, less flexible and less adaptable. The current heuristics approach, while being able to reflect necessary constraints and being highly optimized, are reliant on specific upfront industry knowledge to be successful and can't be reused for other industries. This creates a larger burden on both the supplier and user of the system and increases time and cost to apply into real-world operations.

As will be discussed more fully below, a system and method according to the present invention provide real-time, optimal and actionable solutions for resource utilization, operations change management, and disruption recovery in complex business environments. An object-defined optimization system and method employs an optimizing engine to provides faster, more cost effective and adaptable ways to multiple, different company, market, and industry applications. Objects are acted upon by the engine and include states and rules to allow the identification of feasible solutions and optimal feasible solutions in real-time or near real-time.

In accordance with a preferred embodiment of the present invention, a system and method are disclosed for enabling real-time optimal and actionable solutions for resource utilization, operations change management, and disruption recovery in complex business environments. Such solutions are important, for example, in highly variable, resource intensive, highly regulated, high-consequence industries such as Transportation (Aviation, Trucking, etcetera), Energy (Production, Distribution, Utilities, etcetera), Healthcare (Operating rooms, asset intensive procedures, pharmaceutical medical planning, etcetera), Military and Defense (War fighting units, logistics, and the like), and Telecommunications (mobile). In these markets, the costs of variability, change and disruption management, and resources utilization are vital to quality and safety of service delivery; and the profitability and longevity of the organization.

Plans change regularly especially in dynamic operational environments. According to a preferred embodiment of the present invention, operational environments are permitted to embrace regular, and perhaps constant, change and disruptions and provide actionable, and optimal plans, in real-time, regularly. Organizations, companies, and operations may increase productivity and reliability using fewer resources more efficiently. This results in reduced operating costs, increased revenue generating capacity, and reduced environmental impact (as applicable). Preferably, the method and system may be implemented with traditional off-the-shelf computing hardware.

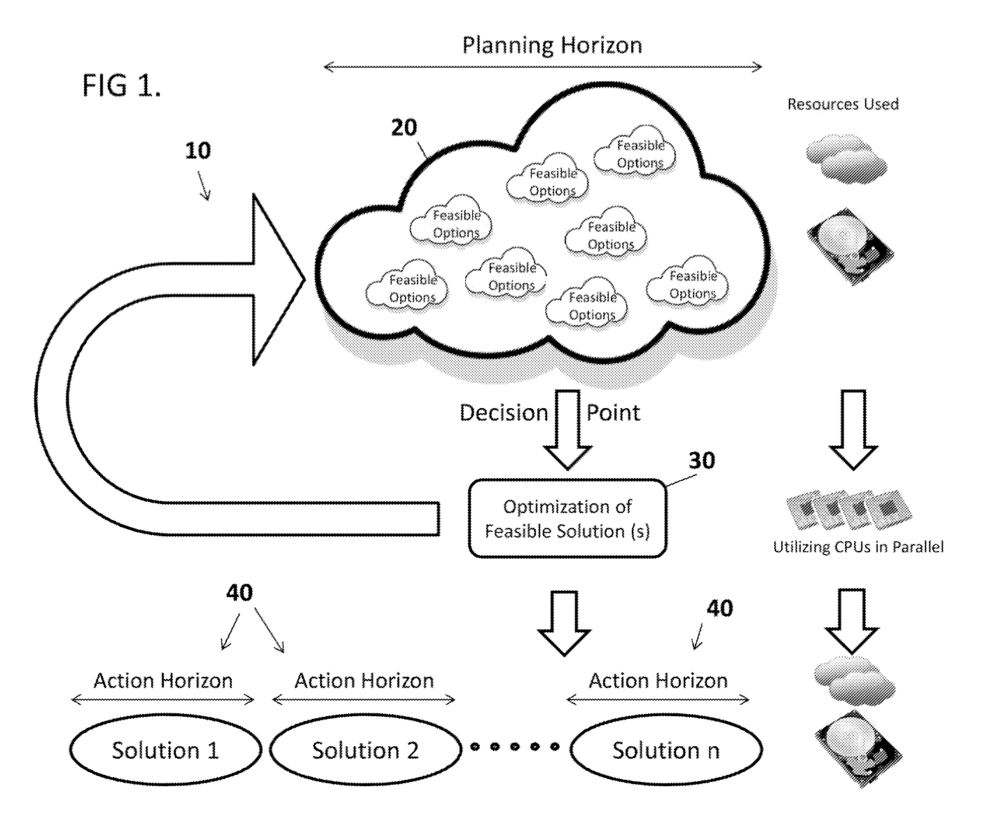

An optimization engine 10, also referred to herein after as “Solver”, is illustrated schematically in FIG. 1 and described below. Optimization engine 10 is an optimization software engine capable of optimizing complex operations, taking into account numerous variables, constraints (both soft and hard), and end goal objectives. Solver 10 separates a feasibility engine 20 that acts on feasibility options 25 and an optimization engine 30 resulting in real-world applicable solutions 40 in very short time frames. Solver 10 may do this in real-time or near real-time, using off-the-shelf computing hardware, resulting in faster and better optimization results with less expensive and more readily available off-the-shelf computing hardware.

Solver 10 is preferably integrated into management and operations systems to create maximum value for business operations. Solver 10 may reside in, for example, dynamic complex environments with at least partially unpredictable futures.

In accordance with another embodiment of the present invention, a method for optimization accelerates proprietary optimization algorithms by exploiting the assumption that the future is unknown and, for various applications, will most likely provide results that differ from any available predictions. This method is further illustrated schematically in FIG. 1.

The optimization solution of the present method operates to keep all future options open unless the choice of a single option must be made, for example due to time or other external constrains. For all variables for which multiple future choices may be kept, they are kept at a “nebulous” state. For example, if an aircraft can depart tomorrow between 10:00am and 11:30 am, no decision is made when exactly it will, in fact, depart, until the range of the variable (in this example—departure time) is reduced to a single data point, such as the point in time the pilot needs to know exactly when to depart his home to get to the aircraft, or when a prior flight is delayed so there is no more slack in the departure time, or for any other number of reasons. This is similar to an ocean wave function in quantum physics being in a superposition of all available states until some measurement is made and the ocean wave function collapses into a single state at the time of measurement. Anything after that time of measurement is once again in a superposition of all available states.

One advantage of optimization engine 30 is processing speed. Since nothing is fixed unless it must be (e.g., decisions are not made unless and until they must be), instead of discarding old plans due to some changes in resources, demand or environment, and then having to recalculate the entire environment, our existing “nebulous” plan is utilized as long as all of its branches (if it is represented as a tree of all possible futures, none of which is realized yet) are feasible with respect to all constraints and rules. If any of the branches become unfeasible—they are eliminated immediately, and if new ones are required, they are created.

Because of the substantial improvement, in processing speed, the optimization engine 10 and its proprietary algorithms can search through larger regions of search space leading to significantly better optimization results at significantly faster times. Also, since the future is unknown and will probably change as time goes by, the system 10 places higher emphasis on the near tern optimization (which is less nebulous) while making sure that the longer term parts of the solution remain feasible while as nebulous as possible.

For optimization applications, a methodology is used that is similar to a quantum physics system being in a superposition of all available states until some measurement is made and the function collapses into a single state at the time of measurement. Anything after that time of measurement is once again in a superposition of all available states.

In accordance with an embodiment of the present invention, a software system and method 10 are provided for enabling real-time, optimal and actionable solutions for resource utilization, operations management, and disruption recovery in complex business environments. This enables complex operations to increase their efficiency where multiple rigid and flexible rules drive the operation and changes and disruptions are a regular occurrence.

In addition, the system 10 may be used very quickly and efficiently to run various future scenarios without impacting the current operating plan and show the differences and impact on the current plan. Further, the system 10 is capable of providing continuous improvement by running on an ongoing basis in the background looking for incremental efficiencies and flagging them when found. Still further, system 10 provides for sliding window planning when a pre-condition is ‘late’ by adapting its planning to the change without reducing the ability to fulfill it. An example of this situation is when a commercial flight is late and a subsequent private flight needs to be pushed out to meet it without degrading the time of the pilots, engines, maintenance, etc.

In accordance with yet another embodiment of the present invention, rapid adaptation and application of an object-defined optimization system and method is disclosed and is desirable for any complex business, company, and industry. Such an optimization engine preferably operates and enables real-time or near real-time, optimal and actionable solutions for resource utilization, operations change management, and disruption recovery in complex business environments. Examples of such environments include highly variable, resource intensive, highly regulated, high-consequence industries such as Transportation (including Aviation and Trucking), Energy (including Production, Distribution and Utilities), Healthcare (Operating rooms, asset intensive procedures and pharmaceutical treatment planning), Military/Defense (including combat units and logistics), and Telecommunications (such as mobile). In these markets, the costs of variability, change and disruption management, and resources utilization are vital to quality and safety of service delivery, and the profitability and longevity of the organization.

Additional applications of a system and method employing object-defined optimization includes: (a) programs that enable real-time, optimal and actionable solutions for resource utilization, operations management, and disruption recovery in complex business environments; (b) programs that enable complex operations to increase their efficiency where multiple rigid and flexible rules drive the operation and changes and disruptions are a regular occurrence: (c) programs that enable scenario planning in which systems and methods may be used very quickly and efficiently to run various future scenarios without impacting the current operating plan and show the differences and impact on the current plan; (d) programs that enable continuous improvement in which the system and method is capable of running on an ongoing basis in the background looking for incremental efficiencies and flagging them when found, and (e) programs that enable sliding-window planning characterized, for example, when a pre-condition is ‘late’, so that a system and method according to the present invention will adapt its planning to the change without reducing the ability to fulfill it (for example, including, but not limited to: in the case in which a commercial flight is late and a connecting flight needs to be pushed out to meet it without degrading the time of the pilots, engines, maintenance).

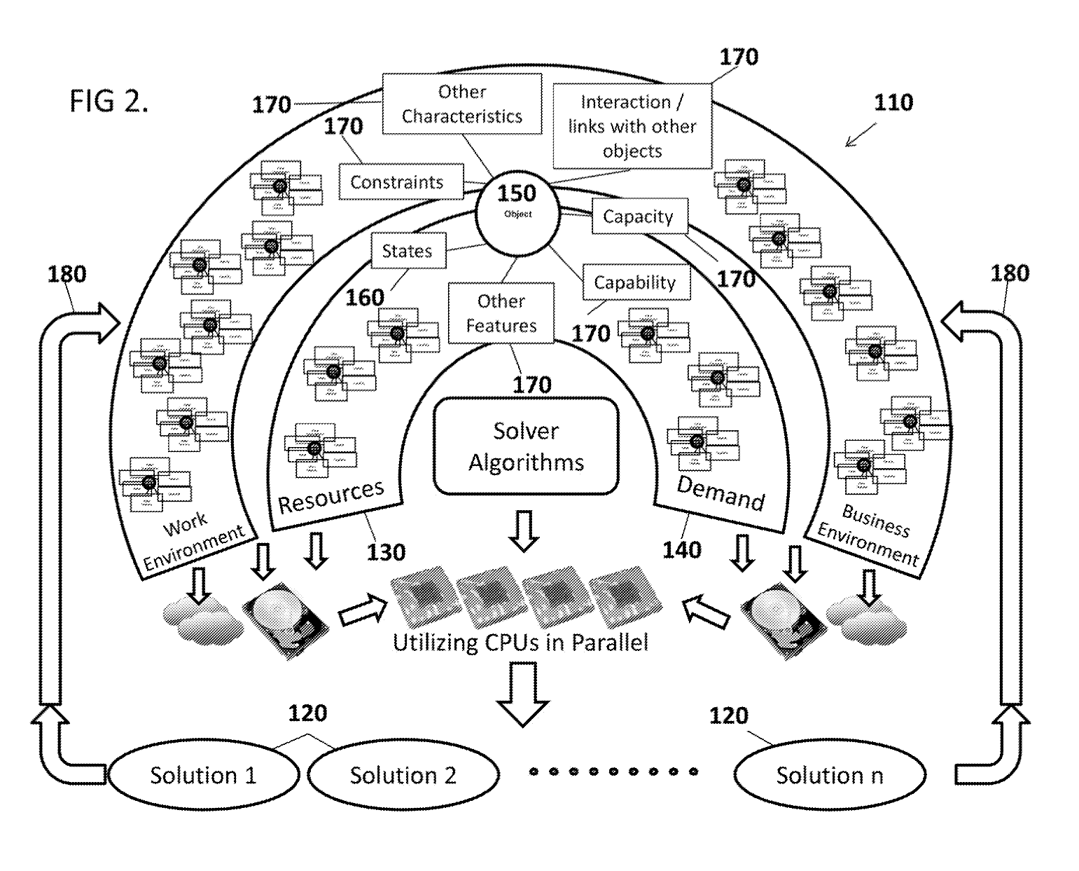

Plans change regularly in operational environments. According to a preferred embodiment of the present invention, an optimization engine, also referred to herein as “Solver” 110, discussed below and illustrated schematically in FIG. 2, allows operations to in embrace, regular and possibly constant change and disruptions and provide actionable, and optimal plans, in real-time, or near real-time regularly and preferably, constantly. This allows organizations, companies, and operations to increase productivity and reliability using less resources and much faster and will lead to reduced operating costs, increased revenue generating capacity, and, where applicable, reduced environmental impact. Preferably, this is accomplished with traditional, off-the-shelf computing hardware.

Optimizing engine (Solver) 110 optimizes complex operations, taking into account numerous variables, constraints (both soft and hard), and end goal objectives. Solver 110 separates the feasibility engine and the optimization engine resulting in real-world applicable solutions 120 in very short time frames. Solver does this all in real-time or near real-time, while using off-the-shelf computing hardware. In accordance with one embodiment of the present invention, Solver 110 is integrated into management and operations systems to create maximum value for operations.

Preferably, customer operations are described in as much detail as possible so that a dedicated optimization engine 10 does not need to be created for each operation, company, and/or industry. As shown in FIG. 2, resources 130 and demands 140 on those resources 130 as are defined and treated as objects 150.

In accordance with the preferred embodiment of the present invention, relevant objects 150 (resources 130 and demands 140) involved in the operation are considered (examples include “pilot”, “plane”, “airport”, “customer”, “customer request”, etc.). All allowed states 160 are listed for each object 150 (including, for example, object “pilot” may be in a “rest” state, an “on duty” state, an “in training” state, etc. and “plane” may be in an “in flight” state, an “in maintenance” state, or an “on the ground ready to fly” state).

In addition, the actions each object 150 is allowed to perform are identified (including for example, “pilot” may get assigned to fly in the right or left seat in the plane, move from some location into another with or without a plane; and “plane” may “take-off” from some airport, “land” into another, “fly”).

Of course other objects and states are possible and likely but are not listed herein for reasons of simplicity. It is understood however, that the listed objects 150, resources 130, demands 140 and states 160 are inclusive and merely illustrative, and many others exist and are applicable.

For each object action, all extra “linked” objects are listed that might be required for the object to perform a particular action (including, for example, for the plane to perform the action “fly” it needs at least one pilot (unless “pilotless” operations are allowed—such as for UAV modeling)).

While these items (or rules) 170 may be customer/market dependent, Solver 110, treats them internally as generic data objects, with each object type having its own possible states, actions and “linked” objects of other types that might be necessary to perform such actions. In addition, other rules further describing the behavior of the objects are defined. Other rules 170, for example, may include, for example: constraints, capabilities, links and interactions with other objects.

In accordance with a preferred embodiment of the invention, rules are embedded into generalized “feasibility check” functions, which, given a current solution 120 (including, for example, schedules of all objects where schedule is a set of actions each object performs), calculates whether a particular solution 120 is feasible. Solver 110 may also generates candidate solutions 120 with the objective to find the optimal feasible solution 180.

In accordance with the preferred embodiment of the present invention, this object-defined optimization provides faster, cost effective, adaptable and improved way to apply an optimization engine 110 to multiple different companies, markets, and industries. These advantages may be obtained due to (a) low level generic modeling of operations that is embedded in highly optimized software code and which may be as efficient as dedicated heuristics and as generic as high level MIP language, (b) medium level feasibility check functionality that contains complex rules and constraints, and (c) high level optimization algorithms that are preferably industry agnostic but may be fine-tuned and configured fur each specific industry.

While preferred and alternative embodiments of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

We claim:

1. A method for operational optimization including the steps of:
identifying at least one feasible option;
optimizing at a last possible point in time to act on the at least one feasible option;
acting on the at least one feasible option; and,
producing a solution based upon optimizing the at least one feasible option.

2. A method for object-defined optimization, including the steps of
defining an object comprising at least one resource and at least one demand upon the resource;
defining rules for the at least one resource and demand in the object;
analyzing the object using the rules and identifying feasible solutions; and,
optimizing at least one feasible solution.

3. A system for optimizing an operation, comprising:
an optimization engine;
a plurality of objects acted upon by the optimization engine; and,
a plurality of states and rules associated with the plurality of objects that allow the optimization engine to identify feasible solutions and optimal feasible solutions.
